(19) United States
(12) Patent Application Publication
(10) Pub. No.: US 2007/0239925 A1
(43) Pub. Date: Oct. 11, 2007

(54) PCI express link, multi host computer system, and method of reconfiguring PCI express link

(75) Inventor: Takahiro Koishi, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/783,346

(22) Filed: Apr. 9, 2007

(30) Foreign Application Priority Data
Apr. 11, 2006 (JP) 2006-108307

(51) Int. Cl. G06F 13/00

(52) U.S. Cl. 710/316

(57) ABSTRACT

A multi-host computer system has a plurality of hosts, a plurality of slot parts, and a PCI Express link that connects the plurality of hosts with the plurality of slots. The PCI Express link connects the plurality of hosts and the plurality of slots so that a combination of them can be changed, while connects the bandwidth of the connect channel so that it can be changed. The PCI Express link connects the plurality of hosts with the plurality of slot parts via first stage and second stage switching elements. The first stage switching elements of the sets the lane assign and the number of lanes of the input/output ports of the plurality of hosts and the second stage switching elements connects the plurality of slot parts with the input/output ports of plurality of hosts so that a combination of the input/output ports and the plurality of slots can be changed.

### BACKGROUND OF THE INVENTION

1. Field of the Invention

The present invention relates to an inner interface for electrically connecting computer system components, and more specifically, to a method of dynamically reconfiguring a PCI (Peripheral Component Interconnect) Express (trademark or registered trademark) link and a PCI Express link.

### INCORPORATION BY REFERENCE

This application is based upon and claims the benefit of priority from Japanese patent application No. 2006-108307, filed on Apr. 11, 2006, the disclosure of which is incorporated herein in its entirety by reference.

2. Description of the Related Art

In the computer system with a plurality of hosts, dynamic I/O (input/output) reconfiguring technique for switching a combination of the host and the slot part exists. In such a conventional technique, however, the bandwidth allocated to each slot part is fixed to the slot part. As such, hardware for satisfying the bandwidth needs to be mounted to the system to apply the card requiring the wide bandwidths to any of the slot part.

As an example of the single host computer system, Japanese Patent Laid-Open No. 2005-141739 and Japanese Patent Laid-Open No. 2005-210653 disclose the system including a PCI Express link that connects a host bridge and the two or more slot parts prepared for that.

Japanese Patent Laid-Open No. 2005-141739 discloses a PCI Express link with a host bridge, a plurality of slots, a switch as a link controller and a link configuration control device.

Japanese Patent Laid-Open No. 2005-210653 discloses a PCI Express link with a host bridge, a plurality of slot parts, a connecting part as a link controller, and a controlling part for performing channel control or channel determination in an image processing system.

The PCI Express link disclosed in the documents can adjust a bandwidth to be allocated to each slot part at the time of reconfiguration.

Each of the PCI Express links disclosed in the documents assumes the single host environment. As such, if the PCI Express link is applied to the multi host system, a connectable slot part is limited for each host. The slot part that can adjust allocation of the bandwidth is limited to the slot part connectable to the same host.

In the PCI Express link with the hosts A and B, and the slot parts a, b, c and d, for example, only the slot part a and the slot part b can be connected to the host A, while only the slot part c and the slot part d can be connected to the host B. Then, the band can be allocated only between the slot part a and the slot part b, while the allocation can be allocated only between the slot part c and the slot part d.

That is to say, one of the hosts cannot connect nor allocate the bandwidth to the slot part under the control of another host. Therefore, any of the PCI Express links disclosed in the documents cannot have satisfactory reconfiguration for the requirements of the card that might be connected with the slot part or the system failure.

### SUMMARY OF THE INVENTION

An object of the present invention is to provide a PCI Express link that can satisfactory reconfigure a combination of the host and a slot part for the requirements of the card that might be connected with the slot part or the system failure in a multi host computer system.

According to the present invention, a PCI Express link that connects a plurality of hosts with a plurality of slot parts via a first stage and a second stage switching means so that a combination of the plurality of hosts and the plurality of slots and a bandwidth of the connection channel can be changed.

The first stage switching means may set the lane assign and the number of the lanes of the input/output ports of the plurality of hosts so that they can be changed, and the second stage switching means may connect the plurality of slot parts with the input/output ports of the plurality of hosts so that a combination of the input/output ports and the plurality of slots can be changed.

The PCI Express link may have an external controller that monitors each state of the plurality of hosts and the plurality of slot parts, while controlling each operation of the first stage and the second stage switching means according to the monitored result.

In the PCI Express link, the external controller may have a management table that stores as updating the association between the monitored result of the plurality of hosts and the plurality of slot parts and the contents of control operations of the first stage and the second stage switching means that should be taken according to the monitored result.

The PCI Express link may have a substitute means that can be used in place of the second stage switching means, if the second stage switching means fails.

Further, the plurality of hosts may have a first host and a second host, wherein the first stage switching means may include a first link controller for setting the lane assign and the number of lanes of the input/output port of the first host so that they can be changed, and a second link controller for setting the lane assign and the number of lanes of the input/output port of the second host so that they can be changed, and the second stage switching means may include a cross point switch for connecting the input/output ports of the first and the second host with the plurality of slot parts so that a combination of the input/output ports and the plurality of slots can be changed.

Moreover, the present invention provides a method for reconfiguring a PCI Express link that connects a plurality of slot parts to a plurality of hosts through a first stage and a second stage switching process so that a combination of the plurality of hosts and the plurality of slots and a bandwidth of the connect channel can be changed.

In the first stage switching process, the lane assign and the number of the lanes of the input/output ports of the plurality of hosts may be set so that they can be changed, and in the second stage switching process, the plurality of slot parts may be connected to the input/output ports of the plurality of hosts so that a combination of the input/output ports and the plurality of slots can be changed.

The method for reconfiguring the PCI Express link may have an external controlling process that monitors each state of the plurality of hosts and the plurality of slot parts, while controlling each operation of the first stage and the second stage switching means according to the monitored result.

In the external controlling process, the method for reconfiguring the PCI Express link may store as updating the association between the monitored result of the plurality of hosts and the plurality of slot parts and control operations of the first stage and the second stage switching means that should be taken according to the monitored result.

The method for reconfiguring the PCI Express link may have a substitute switching process that is executed in place of the second stage switching means, if the second stage switching means fails.

The plurality of hosts may have a first host and a second host, wherein the first stage switching process may include a first link controlling process of setting the lane assign and the number of lanes of the input/output port of the first host so that they can be changed, and a second link controlling process of setting the lane assign and the number of lanes of the input/output port of the second host so that they can be changed, and the second stage switching process may include a cross point switching process that connects the input/output ports of the first and the second host with the plurality of slot parts so that a combination of the input/output ports and the plurality of slots can be changed.

In the multi-host computer system, the PCI Express link according to the present invention may take a combination of all the host and slots for all the requirements of the card that might be connected with the slot that can be considered or all the failures of the system. Accordingly, the PCI Express link according to the present invention can be sufficiently reconfigured.

That is to say, the PCI Express link according to the present invention may flexibly allocate bandwidth according to the state of all the hosts and all the slots in the system.

For example, a bandwidth can be allocated to any slot at a user's timing. That is to say, it is possible to take configuration to value a network service by allocating many bandwidth to the network controller in the daytime hours and to effectively perform backup by allocating many bandwidth to a disk connecting card at night.

### BRIEF DESCRIPTION OF THE DRAWINGS

FIG. 1 is a diagram showing a PCI Express link by the first embodiment of the present invention;

FIG. 2 is a diagram showing a link controller in FIG. 1 in detail;

FIG. 3 is a diagram illustrating a cross point switch in FIG. 1;

FIGS. 4A, 4B and 4C are diagrams illustrating operations of the PCI Express link of the first embodiment of the present invention, showing the PCI Express link before a PCI Express card is inserted;

FIGS. 5A, 5B and 5C are diagrams illustrating operations of the PCI Express link of the first embodiment of the present invention, showing the PCI Express link after the PCI Express card is inserted;

FIGS. 6A, 6B and 6c are diagrams illustrating operations of the PCI Express link of the first embodiment of the present invention, showing the PCI Express link before a slot part fails;

FIGS. 7A, 7B and 7C are diagrams illustrating operations of the PCI Express link of the first embodiment of the present invention, showing the PCI Express link after a slot part fails;

FIGS. 8A, 8B and 8C are diagrams illustrating operations of the PCI Express link of the first embodiment of the present invention, showing the PCI Express link before a host fails;

FIGS. 9A, 9B and 9C are diagrams illustrating operations of the PCI Express link of the first embodiment of the present invention, showing the PCI Express link after a host fails;

FIGS. 10A, 10B and 10C are diagrams illustrating operations of the PCI Express link of the second embodiment of the present invention, showing the PCI Express link before a cross point switch fails;

FIGS. 11A, 11B and 11C are diagrams illustrating operations of the PCI Express link of the second embodiment of the present invention, showing the PCI Express link after a cross point switch fails;

FIGS. 12A, 12B and 12C are diagrams illustrating operations of the PCI Express link of the second embodiment of the present invention, showing the PCI Express link after a normal cross point switch 74 is inserted;

FIGS. 13A, 13B and 13C are diagrams illustrating operations of the PCI Express link of the third embodiment of the present invention, showing the PCI Express link before a cross point switch fails; and

FIGS. 14A, 14B and 14C are diagrams illustrating operations of the PCI Express link of the third embodiment of the present invention, showing the PCI Express link after a cross point switch fails.

### DETAILED DESCRIPTION OF THE EXEMPLARY EMBODIMENTS

A PCI Express link according to the present invention connects a plurality of slot parts to a plurality of hosts via first stage and second stage switching means such that a combination of the plurality of slot parts and the plurality of hosts and a bandwidth of the connecting channel can be changed.

The first stage switching means sets a lane assign and the number of the lanes of an input/output ports of the plurality of hosts to be changeable. The second stage switching means connects the plurality of slot parts to the input/output ports of the plurality of hosts so that a combination of the input/output ports and the plurality of slots can be changed.

The PCI Express link may also include an external controller for monitoring each state of the plurality of hosts and the plurality of slot parts, while controlling each operation of the first stage and the second stage switching means according to the monitored result. The external controller may include a management table for storing as updating the association between the monitored result of the plurality of hosts and the plurality of slot parts and the content of control operations of the first stage and the second stage switching means that should be taken according to the monitored result.

In the PCI Express link, the plurality of hosts has a first host and a second host. The fist stage switching means includes a first link controller for setting the lane assign and the number of lanes of the input/output port of the first host so that they can be changed, and a second link controller for setting the lane assign and the number of lanes of the input/output port of the second host so that they can be changed. The second stage switching means includes a cross point switch for connecting input/output ports of the first and the second host with the plurality of slot parts so that a combination of the input/output ports and the plurality of slots can be changed.

The PCI Express link according to the present invention will be detailed with reference to the drawings.

### First Embodiment

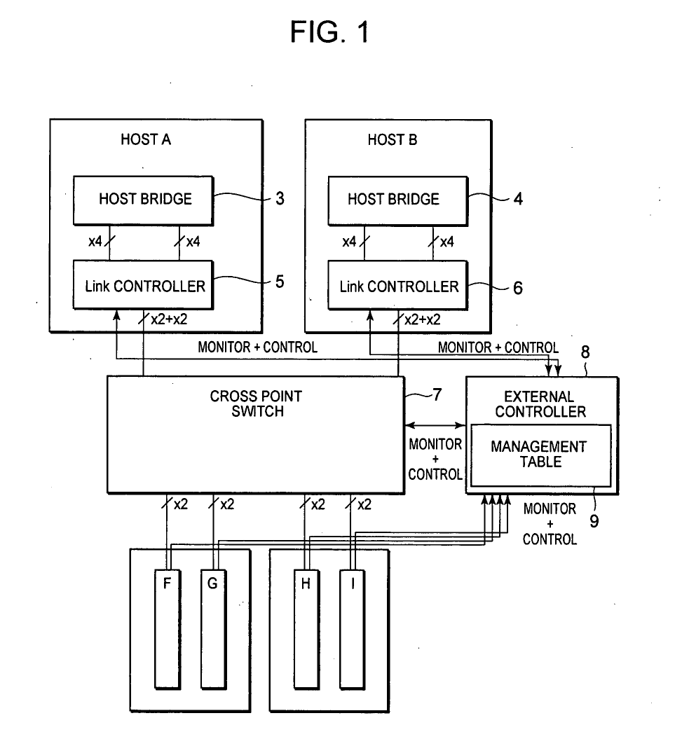

Referring to FIG. 1, the PCI Express link according to the first embodiment of the present invention is applied to a multi-host computer system, and connects between the plurality of hosts A, B, and the plurality of slot parts F, G, H and I via the first stage and the second stage switching means so that a combination of the hosts A, the hosts B and the slot parts F, G, H and I and the bandwidth of the connecting channel can be changed.

The host A has a host bridge 3 and a link controller 5. The host bridge 3 has two PCI Express ports with a four-lane bandwidth. The link controller 5 can be connected with the PCI Express port of the host bridge 3. The host B has a host bridge 4 and a link controller 6. The host bridge 4 has two PCI Express ports with a four-lane bandwidth. The link controller 6 can be connected with the PCI Express port of the host bridge 4.

In the PCI Express link, the first stage switching means includes a link controller 5 for setting the lane assign and the number of lanes of the input/output ports of the host A so that they can be changed, and the link controller 6 for setting the lane assign and the number of lanes of the input/output ports of the host B so that they can be changed.

The second stage switching means includes a cross point switch 7 for connecting the input/output ports of the host A and the host B with the slot parts F, G, H and I so that a combination of the input/output ports and the slot parts F, G, H and I can be changed.

The PCI Express link has an external controller 8 for monitoring each state of the plurality of hosts and the plurality of slot parts, also monitoring each state of the host A and the host B for controlling each operation of the first stage and the second stage switching means and the slot parts F, G, H and I according to the monitored result, while controlling each operation of the link controllers 5 and 6 and the cross point switch 7 according to the monitored result. The external controller 8 has a management table 9 for storing as updating the association between the monitored result of the hosts A and B and the slot parts F, G, H and I and content of control operations of the link controllers 5 and 6 and the cross point switch 7 that should be taken according to the monitored result.

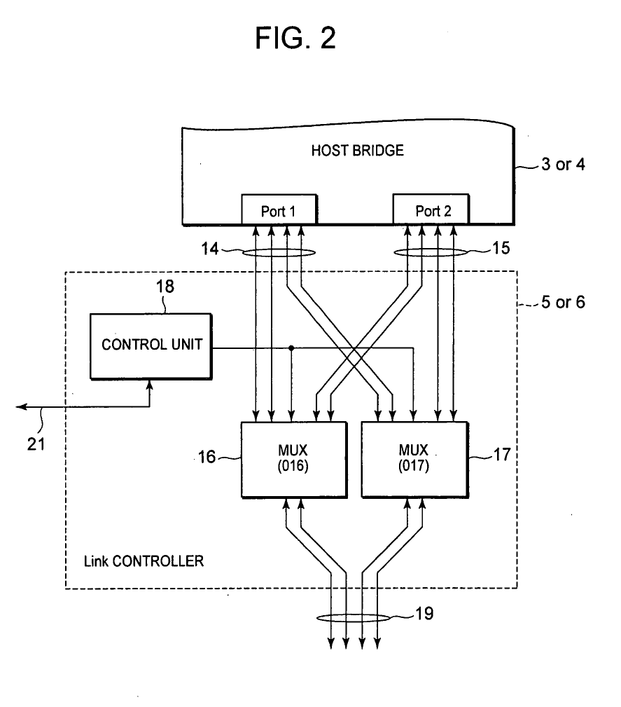

FIG. 2 shows an example of detailed configuration of the link controller 5 or 6 shown in FIG. 1. In FIG. 2, an interface 21 that receives a switching instruction from the external controller controls switching parts (MUltipleX switch) 16, 17. The host bridge 3 or 4 and the link controller 5 or 6 can be connected by two PCI Express buses 14, 15 having the bandwidth for four lanes respectively. An I/O connecting side port 19 of the link controller 5 or 6 has a bandwidth for four lanes of the PCI Express.

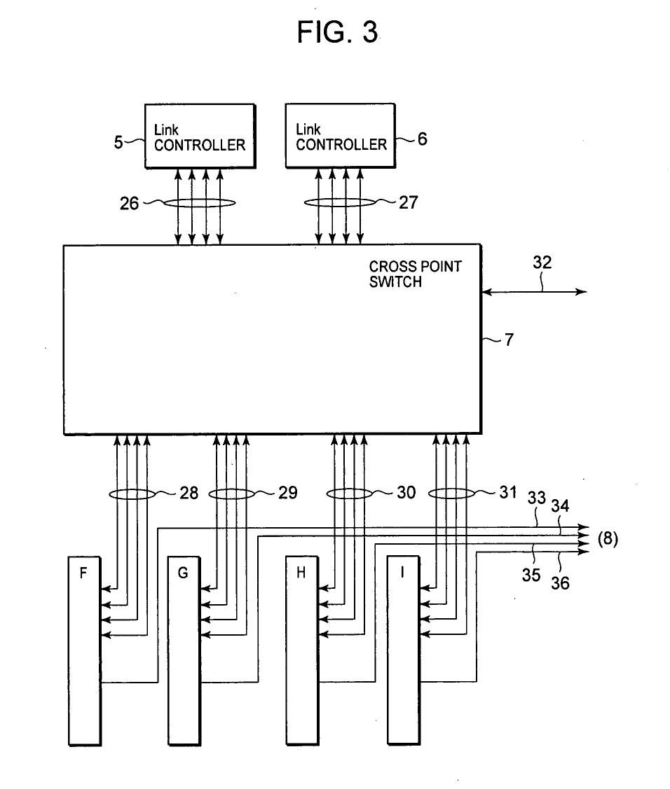

FIG. 3 shows an example of the connection of the cross point switch 7 shown in FIG. 1. As shown in FIG. 3, the slot parts F, G, H and I can be connected with the cross point switch 7 via the PCI Express buses 28, 29, 30 and 31 having a bandwidth for four lanes each. The cross point switch 7 is set by a cross point switch controlling signal 32 from the external controller 8. Each of the slot parts F, G, H and I has each of diagnosing buses 33, 34, 35 and 36 for the external controller 8 to check a required bandwidth for the PCI Express card. As the detailed and specific configuration of the cross point switch 7 is known to those skilled in the art and are not directly connected with the contents of the present invention, they are omitted from the description.

Although two ports with four-lane bandwidth are assumed as the PCI Express port from the host bridge in the embodiment, much more ports and bandwidth can be prepared.

The link controller of FIG. 2 may be configured by a cross switch.

### (Insertion of the PCI Express Card)

Next, an operation where the PCI Express card requiring a bandwidth more than that of the slot part is newly mounted will be described.

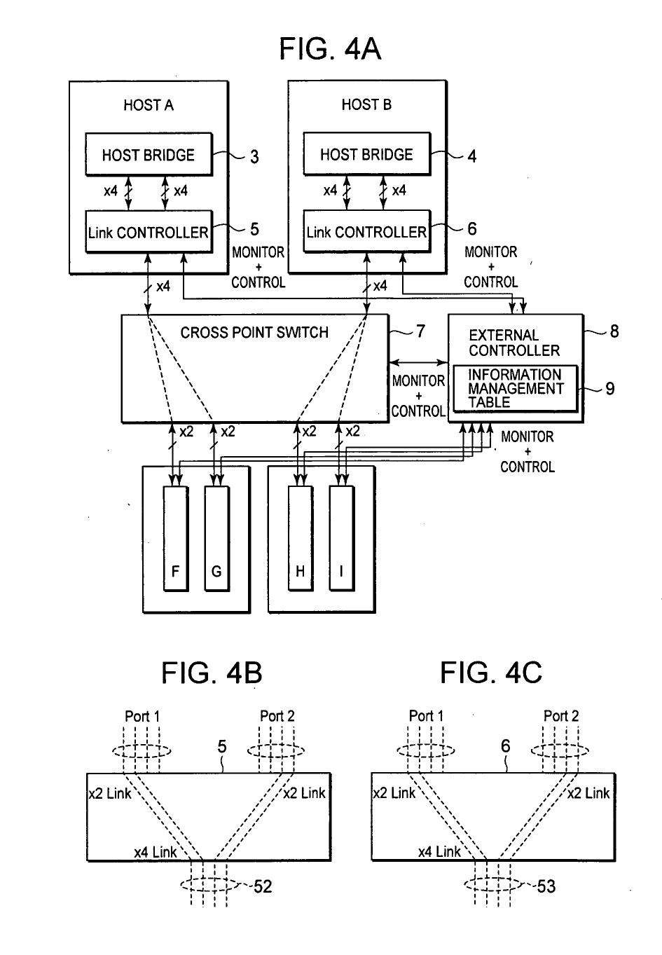

FIG. 4A shows a system before the PCI Express card is mounted.

In FIG. 4A, the host bridge 3 of the host A and the host bridge 4 of the host B have the PCI Express port of four-lane bandwidth, respectively.

In FIG. 4B, the link controller 5 narrows the port 1 and 2 of the host bridge 3 by two lanes each to become a single PCI Express link 52 of a four-lane bandwidth as denoted by a dashed line.

In FIG. 4C, the link controller 6 also narrows the port 1 and 2 of the host bridge 4 by two lanes each to become a single PCI Express link 53 of a four-lane bandwidth as denoted by a dashed line.

As denoted by a dashed line in FIG. 4A, the cross point switch 7 makes two PCI Express link of four-lane bandwidth of the link controllers 5 and 6 four PCI Express links of two-lane bandwidth. The four PCI Express links of two lanes of the cross point switch 7 are connected with the slot parts F, G, H and I, respectively.

As no card is inserted in the slot parts at this moment, all the slot parts are not powered on.

The host bridge 3 of the host A periodically monitors whether a card with powered on is inserted into each of the slot parts F and G that are linked with the PCI Express ports 1 and 2 respectively. The host bridge 4 of the host B also periodically monitors whether a card with powered on is inserted into each of the slot parts H and I that are linked with the PCI Express ports 1 and 2 respectively.

Now, the PCI Express card is inserted into the slot part G. The PCI Express card requires four lanes bandwidth.

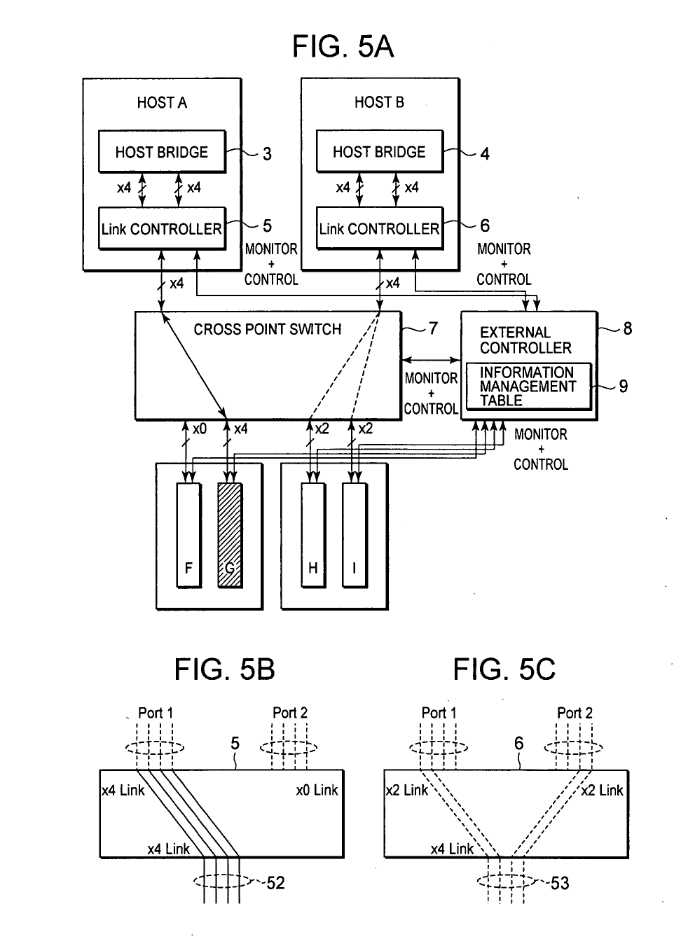

Referring to FIG. 5A, when the PCI Express card is inserted into the slot part G, the Presence signal of the slot part G changes and is notified to the external controller 8. At this moment, the slot part G is not powered on.

The external controller 8 that detected a change in the Presence signal reads, via the diagnosing bus, a used bandwidth of the PCI Express card.

The external controller 8 determines that the bandwidth required by the PCI Express card is more than that of the currently allocated slot part by referencing the management table 9 and outputs a control signal to the link controller 5 and the cross point switch 7.

The link controller 5 receives the control instruction from the external controller 8, then changes the link of two-lane bandwidth between the port 1 of the host bridge 3 and a PCI Express link 52 and a link of two lanes between the port 2 and the PCI Express link 52 to the link of four-lane bandwidth between the port 1 of the host bridge 3 and the PCI Express link 52 as shown in FIG. 5B.

As denoted by a dashed line in FIG. 5C, the link of two-lane bandwidth between the port 1 of the host bridge 4 in the link controller 6 and the PCI Express link 53 and the link of two-lane bandwidth between the port 2 and the PCI Express link 52 are maintained.

The cross point switch 7 that received the control instruction from the external controller 8 resolves the link between the host A (the PCI Express link 52 of the link controller 5) and the slot part F among the slot parts F and G, while changing the link between the host A and the slot part G from two-lane bandwidth to four-lane bandwidth as shown in FIG. 5A.

Each of the link of two-lane bandwidth between the host B (the PCI Express link 53 of the link controller 6) and the slot parts H and I in the cross point switch 7 is maintained.

The external controller 8 starts electrical supply to the slot part G after the links are changed.

The slot part G supplied with power responds to the monitoring by the host bridge 3. The host bridge 3 that received the response from the slot part G issues a link width arbitration command to the PCI Express card inserted in the slot part G that is linked with the PCI Express port 1. Then, as shown by solid lines in FIGS. 5A and 5B, the host A and the PCI Express card mounted to the slot part G are connected by four-lane bandwidth via the link controller 5 and the cross point switch 7 and the system operates by using the PCI Express card.

### (Slot Part Failure)

Next, operations when the slot part fails will be described.

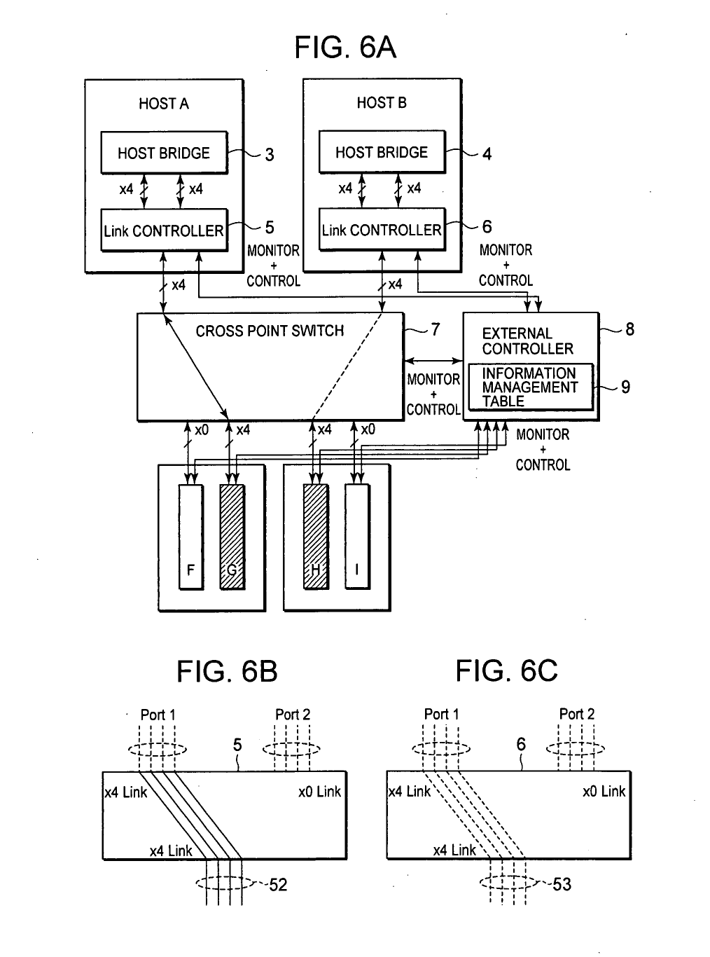

FIG. 6A shows a system before the slot part fails.

In FIG. 6A, the PCI Express cards requiring four-lane bandwidth are inserted to the slot parts G and H, respectively. In the system, the PCI Express card inserted in the slot part G is used, and the PCI Express card inserted in the slot part H is unused as a spare.

The host bridge 3 of the host A and the host bridge 4 of the host B have the PCI Express ports of four-lane bandwidth respectively.

The link controller 5 makes the PCI Express link 52 of the four-lane bandwidth from the port 1 of the host bridge 3 as shown in a solid line in FIG. 6B, while making 0-lane bandwidth between the port 2 and the PCI Express link 52.

The link controller 6 makes the PCI Express link 53 of the four-lane bandwidth from the port 1 of the host bridge 4 as shown in a dashed line in FIG. 6C, while making 0-lane bandwidth between the port 2 and the PCI Express link 53.

The cross point switch 7 makes the PCI Express link of the four-lane bandwidth between the link controller 5 and the slot part G as shown in a solid line in FIG. 6A, while making the PCI Express link of four-lane bandwidth between the link controller 6 and the slot part H as shown in a dashed line. To the slot parts F and I, it makes 0-lane bandwidth.

As a card is inserted in the slot part G at this moment, the slot part G is powered on. Although a card is inserted in the slot part H, the slot part H as a spare is not powered on. The management table 9 of the external controller 8 stores in advance that the spare slot part H is not powered on in a usual occasion.

The host bridge 3 of the host A periodically monitors whether the power supplied cards are inserted into the slot parts F and G that are linked with the PCI Express ports 1 and 2 respectively. The host bridge 4 of the host B also periodically monitors whether the power supplied cards are inserted into the slot parts H and I that are linked with the PCI Express ports 1 and 2 respectively.

The power supplied slot part G responds to the monitor by the host bridge 3. The host bridge 3 that received the response from the slot part G issues a link width arbitration command to the PCI Express card inserted in the slot part G linked with the PCI Express port 1. Then, it is connected with four-lane bandwidth between the host A and the PCI Express card mounted to the slot part G via the link controller 5 and the cross point switch 7 as denoted by a solid line in FIGS. 6A and 6B, and the system operates by using the PCI Express card.

Now, the slot part G of the system shown in FIG. 6A fails to be out of order.

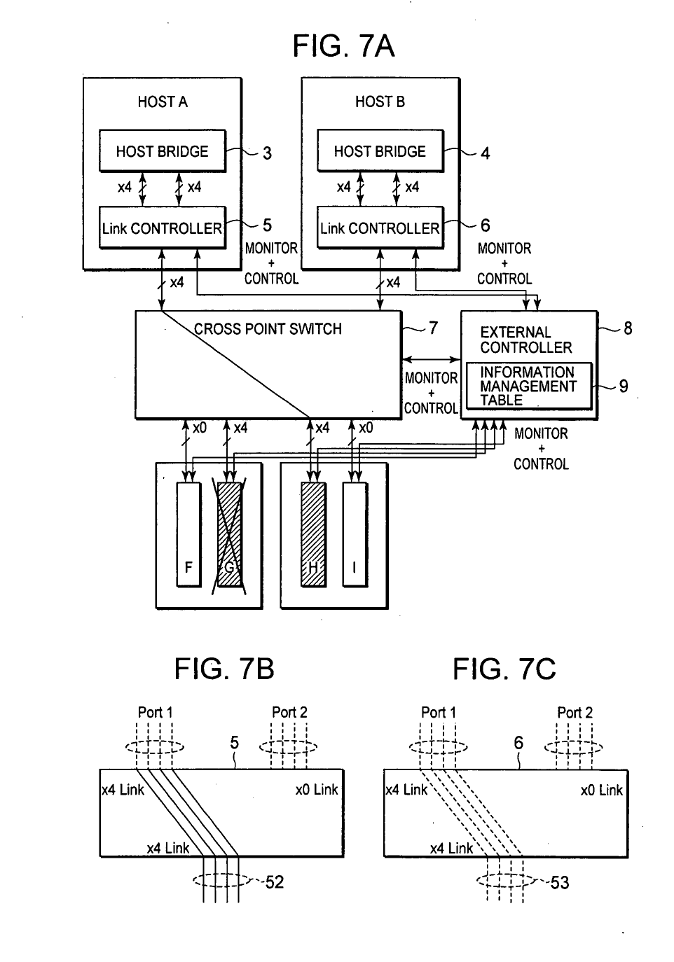

Referring to FIG. 7A, the external controller 8 that detected the failure of the slot G recognizes the unused slot part H that is allocated to the host B by referencing to the management table 9 and outputs a control instruction to the cross point switch 7.

The cross point switch 7 that received the control instruction from the external controller 8 resolves the link between the host A (the PCI Express link 52 of the link controller 5) and the slot part G and the link between the host B (the PCI Express link 53 of the link controller 6) and the slot part H, while laying a link of four-lane bandwidth between the host A and the slot part H as shown in FIG. 7A.

In FIG. 7B, the link of four-lane bandwidth between the port 1 of the host bridge 3 in the link controller 5 and the PCI Express link 52 is maintained as denoted by a solid line. In FIG. 7C, the link of four-lane bandwidth between the port 1 of the host bridge 4 in the link controller 6 and the PCI Express link 53 is also maintained as denoted by a dashed line.

The external controller 8 starts power supply to the slot part H after the control of link is changed.

The power supplied slot part H responds to the monitor by the host bridge 3. The host bridge 3 that received the response from the slot part H issues a link width arbitration command to the spare PCI Express card inserted in the slot part H linked with the PCI Express port 1. Then, the host A and the PCI Express card mounted to the slot part H are connected with four-lane bandwidth via the link controller 5 and the cross point switch 7 as denoted by a solid line in FIGS. 7A and 7B, and the system operates by using the PCI Express card.

### (Host Failure)

Next, operations when the host fails will be described.

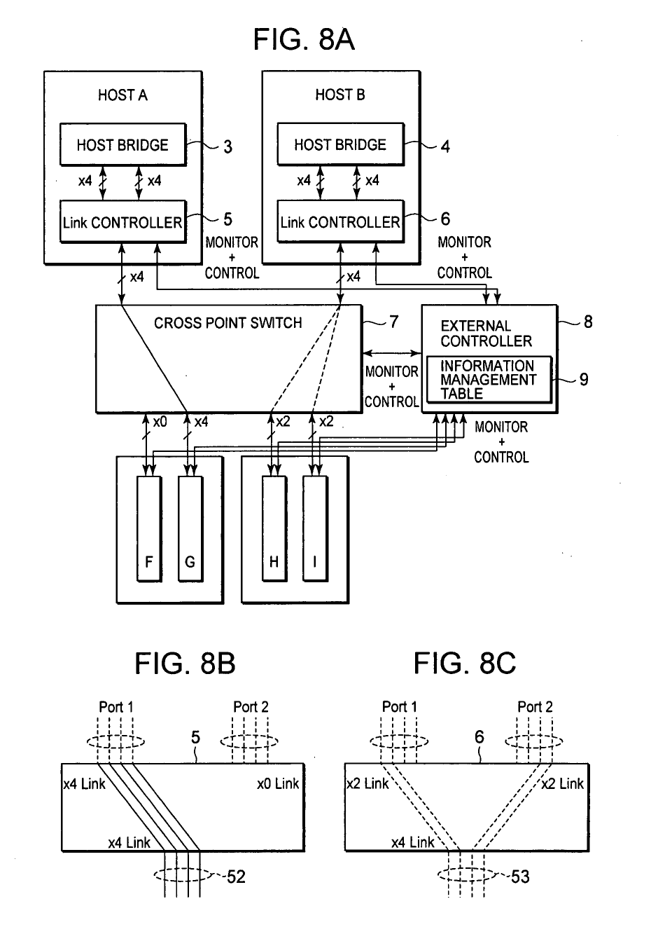

As denoted by a solid line in FIG. 8A and FIG. 8B, at the present moment, the presently used host A and the PCI Express card mounted to the slot part G are connected by four-lane bandwidth via the link controller 5 and the cross point switch 7, and the system operates by using the PCI Express card.

As denoted by a dashed line in FIG. 8A and FIG. 8C, links of two-lane bandwidth are laid between the spare host B and the slot part H and I via the link controller 6 and the cross point switch 7.

Now, the host A of the system shown in FIG. 8A failed.

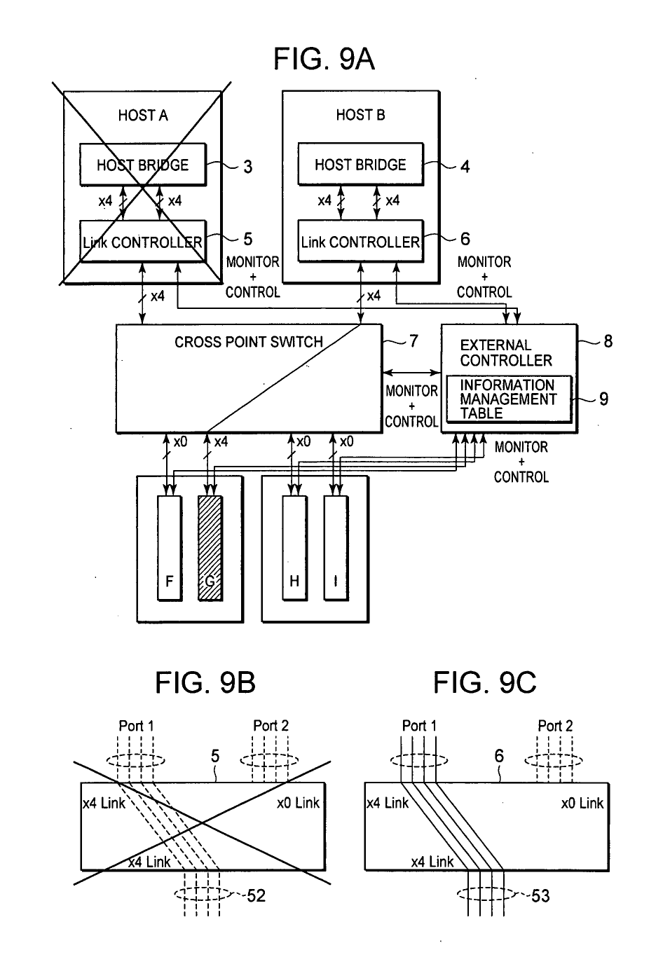

Referring to FIG. 9A, the external controller 8 that detected the failure of the host A recognizes the spare host B by referencing the management table 9 and outputs a control instruction to the link controller 6 and the cross point switch 7.

The link controller 6 that received the control instruction from the external controller 8 changes the link of two-lane bandwidth between the port 1 of the host bridge 4 and the PCI Express link 53 and the link of two-lane bandwidth between the port 2 and the PCI Express link 53 to the link of four-lane bandwidth between the port 1 of the host bridge 4 and the PCI Express link 53 as shown in FIG. 9C.

As the host A failed, the link controller 5 is out of order as shown in FIG. 9B.

The cross point switch 7 that received the control instruction from the external controller 8 resolves the link between the host A (the PCI Express link 52 of the link controller 5) and the slot part and G and the link of two-lane bandwidth between the host B (the PCI Express link 53 of the link controller 6) and the slot parts H and I as shown in FIG. 9A, while laying a link of four-lane bandwidth between the host B and the slot part G.

The slot part G responds to the monitor by the spare host bridge 4. The host bridge 4 that received the response from the slot part G issues a link width arbitration command to the PCI Express card inserted in the slot part G linked with the PCI Express port 1. Then, as shown by a solid line in FIG. 9A and FIG. 9C, the host B and the PCI Express card mounted to the slot part G are connected with four-lane bandwidth via the link controller 6 and the cross point switch 7, and the system continuously operates by using the PCI Express card.

The advantage of the switching is as below. For example, if the system shown in FIG. 8A is for executing an application with MAC (Media Access Control) of the PCI Express card inserted in the slot part G being a key does not use the PCI Express card with the same MAC address, i.e., the PCI Express card inserted in the slot part G when the host A is changed to the host B in the waiting state in response to the failure of the host A, the application becomes out of use. In the present invention, as shown in FIG. 9A, the connection channel is also automatically changed as the host A is changed to the host B in the waiting state. Accordingly, the PCI Express card inserted in the slot part G added with a particular MAC address that was used in the presently used host A needs not to be physically changed to the slot part H or I that is prepared for the host B in the waiting state.

### Second Embodiment

The PCI Express link of the second embodiment of the present invention has basically the same configuration of that of the PCI Express link of the first embodiment 1 except for a configuration of the second stage switching means. Therefore, the same configuration as that of the first embodiment will be omitted from the description.

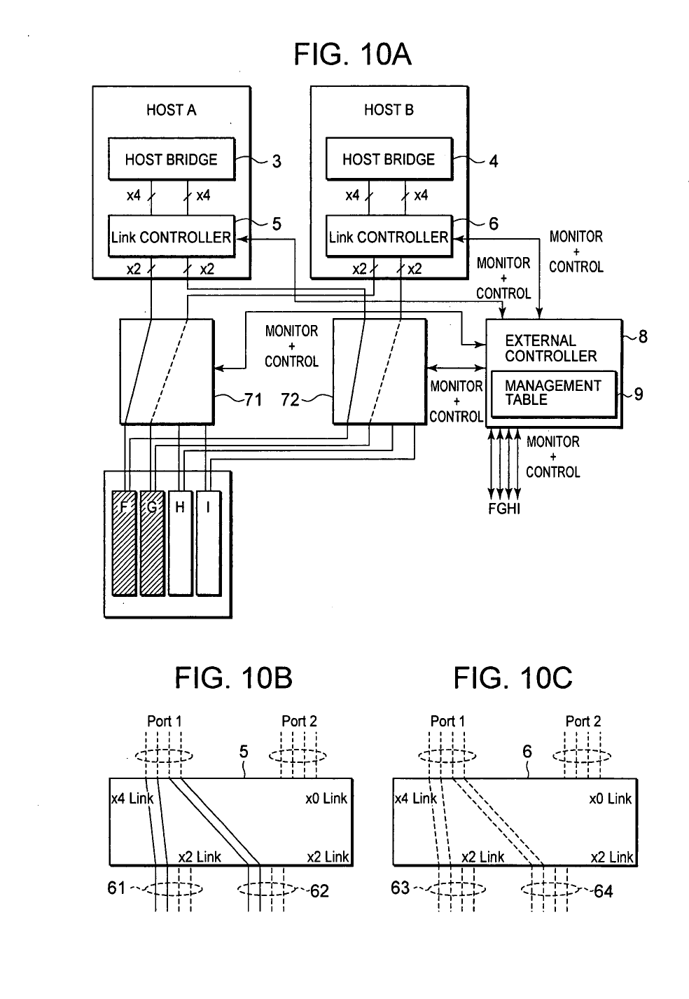

Referring to FIG. 10A, in the PCI Express link, the first stage switching means includes a link controller 5 for setting the lane assign and the number of the lanes of the input/output ports of the host A to be changeable, and a link controller 6 for setting the lane assign and the number of lanes of the input/output ports of the host B to be changeable.

The second stage switching means includes cross point switches 71, 72 that connects the slot parts F, G, H and I to the input/output ports of the hosts A and B so that a combination between the input/output ports and the slot parts can be changed.

The cross point switch 71 and 72 are redundant, being improved in its availability when the cross point switch fails.

### (Cross Point Switch Failure)

Operations when the cross point switch fails will be described below.

As denoted by a solid line in FIG. 10B, the link controller 5 of the host A has two PCI Express links 61 and 62 by two-lane bandwidth respectively at present. The PCI Express links 61 and 62 are connected with the cross point switches 71 and 72, respectively. As denoted by a solid line in FIG. 10A and FIG. 10B, the host A and the PCI Express card mounted to the slot part F are connected by two PCI Express links of two-lane bandwidth via the link controller 5 and the cross point switches 71 and 72, and the system operates by using the PCI Express card.

As shown by a dashed line in FIG. 10C, the link controller 6 of the host B has two PCI Express links 63 and 64 of two-lane bandwidth. The PCI Express links 63 and 64 are connected with the cross point switches 71 and 72, respectively. As denoted by a dashed line in FIG. 10A and FIG. 10B, two PCI Express links of two-lane bandwidth each is laid between the host B and the slot part G via the link controller 6 and the cross point switches 71 and 72. The spare PCI Express card is inserted in the slot part G, the PCI Express card is not powered. The management table 9 of the external controller 8 stores that the spare slot part G, is not powered in a usual case in advance.

The slot parts H and I shown in FIG. 10A are spare slots, being not connected with the hosts A and B.

Now, the cross point switch 71 fails.

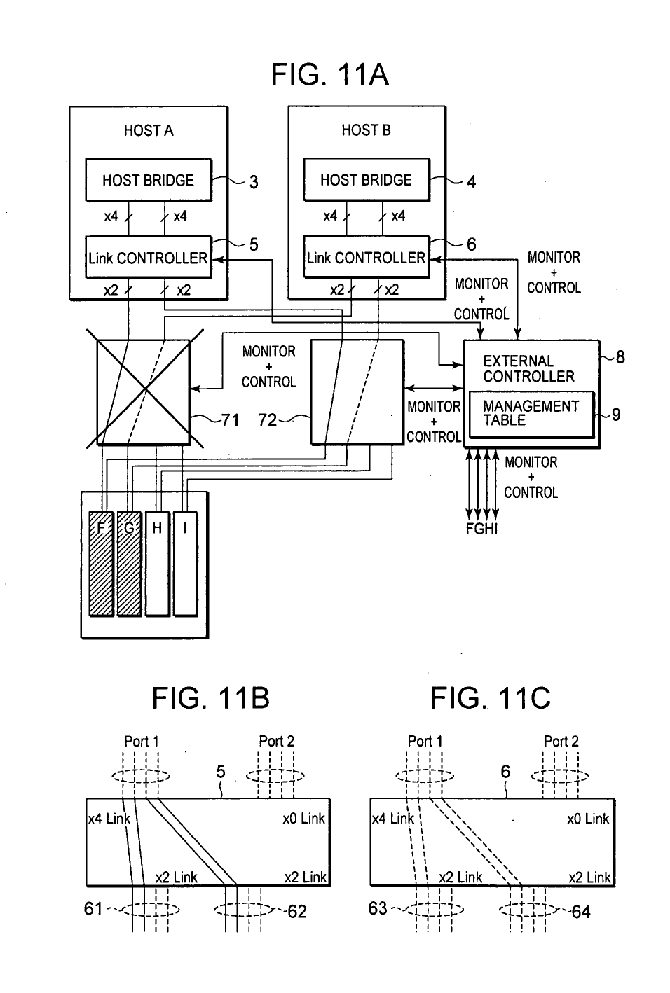

Referring to FIGS. 11A to 11C, the external controller 8 that detected failure of the cross point switch 71 performs disconnecting processing of the cross point switch 71 by referencing to the management table 9. The PCI Express can keep operation even if the number of lanes of links degrades from the viewpoint of the specification. As such, the host A is kept connected with the slot part F with two-lane bandwidth via only the cross point switch 72 after the cross point switch 71 is disconnected. Therefore, the connection between the host A and the slot part F is continued and the system keeps operation even if the lane degrades.

The host B also keeps its link with the slot part G via only the cross point switch 72 even after the cross point switch 71 is disconnected. Therefore, the link with two-lane bandwidth between the host B and the slot part G is maintained.

The spare slot parts H and I are not connected with the hosts A and B so that they are not suffered from failure of the cross point switch 71.

During such provisional operation, a user removes the failed cross point switch 71.from the system and prepares the cross point switch as repaired or another normal cross point switch as a cross point switch 74.

Now, a user inserts the cross point switch 74 into the system.

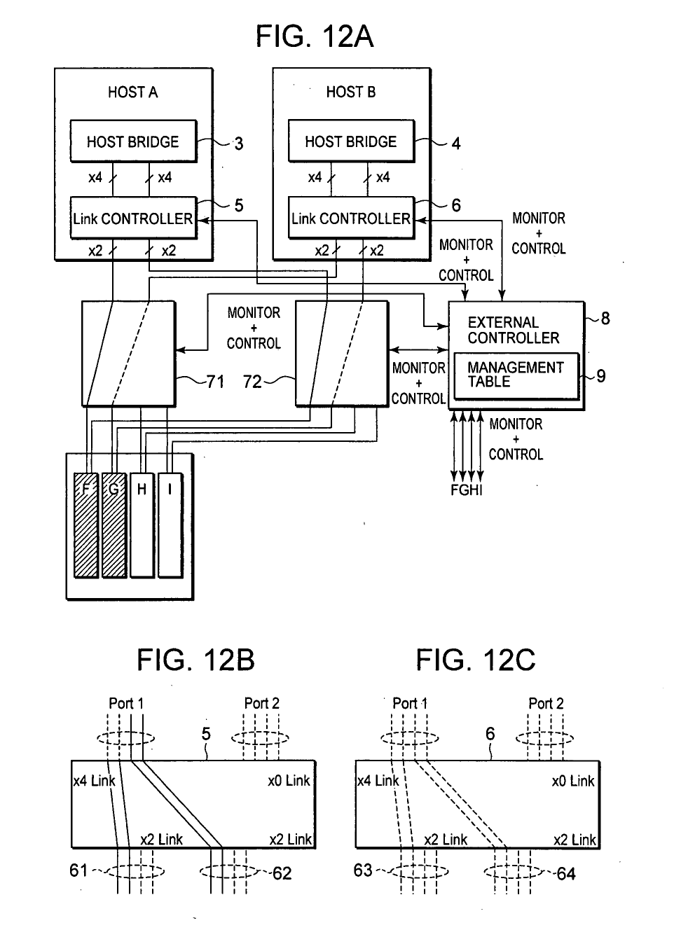

Referring to FIG. 12A to 12C, the external controller 8 that detected that a normal cross point switch 74 was inserted outputs a control instruction to the cross point switch 74.

The cross point switch 74 that received the control instruction from the external controller 8 lays the link of two-lane bandwidth between the host A (the PCI Express link 61 of the link controller 5) and the slot part F and the link of two-lane bandwidth between the host B (the PCI Express link 63 of the link controller 6) and the slot part G as shown in FIG. 12A.

Then, the slot part F responds to the monitor by the host bridge 3. The host bridge 3 that received the response from the slot part F issues a link width arbitration command to the PCI Express card inserted in the slot part F linked with the PCI Express ports 1 and 2.

In this manner, as denoted by a solid line in FIG. 12A and FIG. 12B, the host A and the PCI Express card mounted to the slot part F are connected by two PCI Express links of two-lane bandwidth via the link controller 5 and the cross point switches 74 and 72, and the system operates by using the PCI Express card.

As denoted by a dashed line in FIG. 12A and FIG. 12C, two PCI Express links of two-lane bandwidth each is laid between the host B and the slot part G via the link controller 6 and the cross point switches 74 and 72. The spare PCI Express card is inserted in the slot part G, but the PCI Express card is not powered.

As such, in the embodiment, the lane to be used by the host is redundant by the cross point switch and connected with the slot part, the link between the host and the PCI Express card is not disconnected when the cross point switch fails.

### Third Embodiment

The PCI Express link by the third embodiment of the present invention has basically the same configuration as the PCI Express link of the first embodiment, except for features of the second stage switching means and configuration of its lower side. As such, the same configuration as that of the first embodiment will be omitted from the description.

The PCI Express link of the third embodiment of the present invention is adapted to be appropriate when the number of slots comes before availability in requirement.

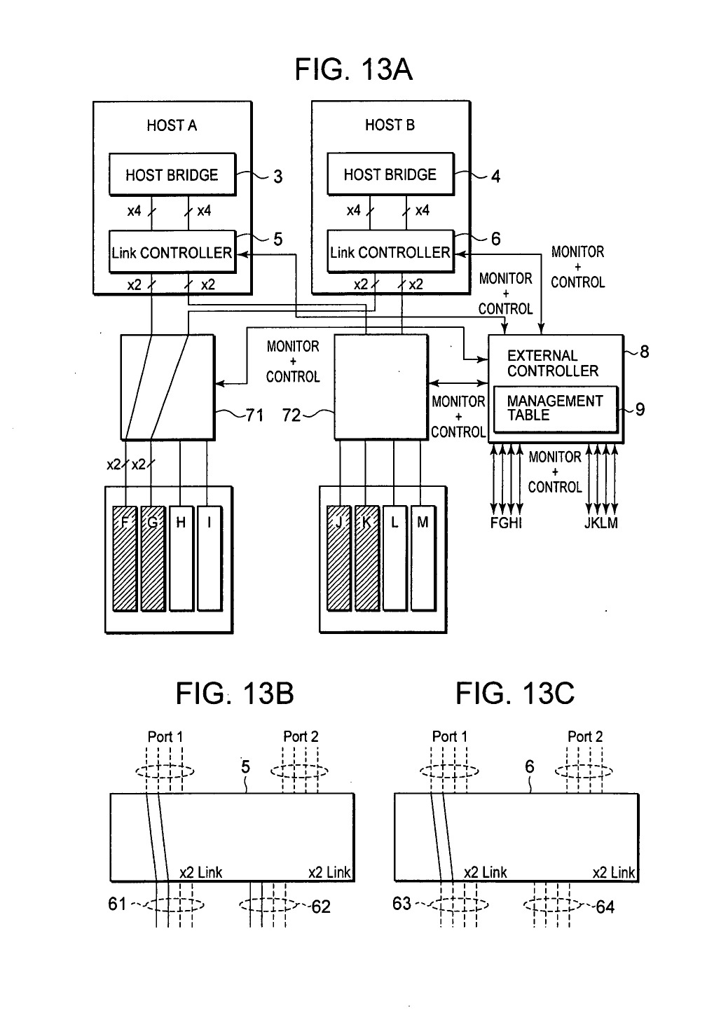

Referring to FIG. 13A, the first stage switching means in the present PCI Express link includes the link controller 5 for setting the lane assign and the number of lanes of the input/output ports of the host A so that they can be changed and the link controller 6 for setting the lane assign and the number of lanes of the input/output ports of the host B so that they can be changed.

The second stage switching means includes a cross a point switch 71 that connects the slot parts F, G, H and I to the input/output ports of the hosts A and B so that a combination between the input/output ports and the slot parts F, G, H and I can be changed, and a cross a point switch 72 that connects the slot parts J, K, L and M to the input/output ports of the hosts A and B so that a combination between the input/output ports and the slot parts J, K, L and M can be changed.

As shown in FIG. 13B, the link controller 5 of the host A has two PCI Express links 61 and 62 of two-lane bandwidth each. The PCI Express links 61 and 62 are connected with the cross point switches 71 and 72 respectively. As shown in FIG. 13C, the link controller 6 of the host B has two PCI Express links 63 and 64 of two-lane bandwidth respectively. The PCI Express links 63 and 64 are connected with the cross point switches 71 and 72, respectively.

### (Cross Point Switch)

At a normal occasion, as denoted by a solid line in FIG. 13A to 13C, the host A and the PCI Express card mounted on the slot part are connected by PCI Express link of two-lane bandwidth via the link controller 5 and the cross point switch 71. The host B and the PCI Express card mounted to the slot part G are connected by one PCI Express link of two-lane bandwidth via the link controller 6 and the cross point switch 71. In this manner, the system operates by using the two PCI Express cards inserted in the slot parts F and G.

Although the spare PCI Express cards are inserted in the slot parts J and K, the PCI Express cards are not powered. The management table 9 of the external controller 8 stores that the spare slot part J and K are not powered in a normal occasion in advance.

Now, the cross point switch 71 fails.

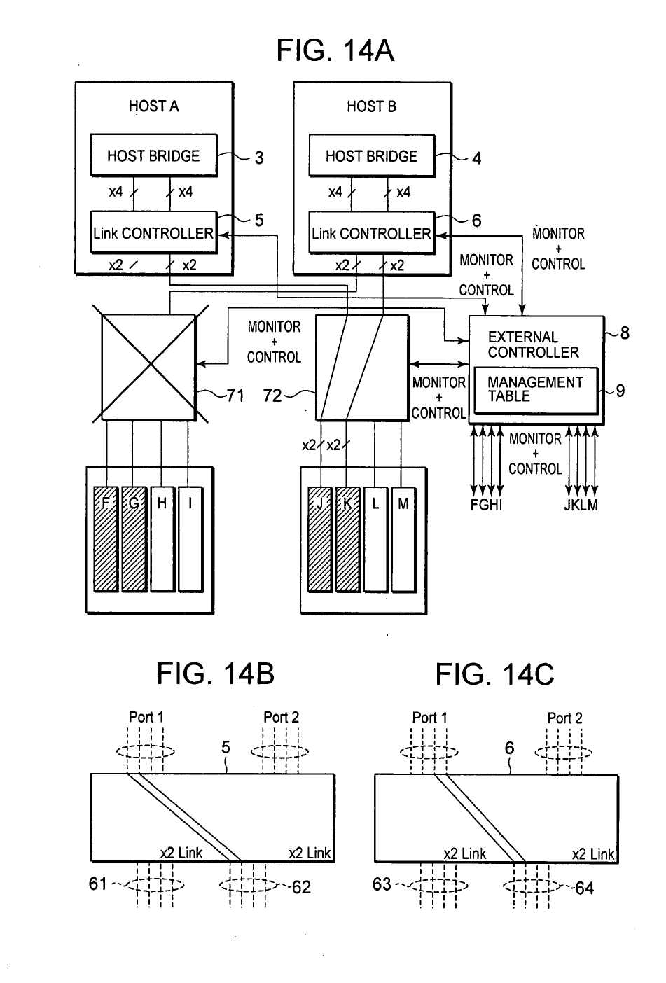

The external controller 8 that detected that the cross point switch 71 failed performs disconnecting processing on the cross point switch 71 and its lower the slot parts F to I by referencing to the management table 9, while outputting a control instruction to the cross point switch 72 as shown in FIG. 14A.

The cross point switch 72 that received the control instruction from the external controller 8 lays one PCI Express link of two-lane bandwidth between the host A and the PCI Express card mounted to the slot part J, while one PCI Express link of two-lane bandwidth between the host B and the PCI Express card mounted to the slot part K.

Then, the slot parts J and K are powered.

The power supplied slot part J responds to the monitor by the host bridge 3. Similarly, the power supplied slot part K responds to the monitor by the host bridge 4.

The host bridge 3 that received a response from the slot part F issues a link width arbitration command to the PCI Express card inserted in the slot part J linked with the PCI Express port 2. Similarly, the host bridge 4 that received a response from the slot part K issues a link width arbitration command to the PCI Express card inserted in the slot part K linked with the PCI Express port 2.

In such a manner, as denoted by a solid line in FIG. 14A to 14C, the host A and the PCI Express card mounted to the slot part J are connected by one PCI Express link of two-lane bandwidth via the link controller 5 and the cross point switch 72. The host B and the PCI Express card mounted to the slot part K are connected by one PCI Express link of two-lane bandwidth via the link controller 6 and the cross point switch 72. In such a manner, the system operates by using two PCI Express cards inserted in the slot parts J and K.

If either the cross point switches 71 and 72 has a failure, both the host A and the host B lose one slot, but they can use twice the number of slots than in the second embodiment in a normal occasion (when no failure has occurred).

As such, by applying the present invention, availability and operability can be selected according to the user's service system.

Although the first and the second stage switching means operate according to the control instruction from the external controller 8 in the embodiment in the above-mentioned embodiments, in the present invention, a user may operate the first and the second stage switching means.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A PCI Express link comprising first and second stage switching means that connect a plurality of hosts with a plurality of slot parts so that a combination of the plurality of hosts and said plurality of slot parts and a bandwidth of a connection channel can be changed.

2. A PCI Express link, comprising:
first stage switching means for setting lane assign and number of lanes connected to a plurality of slot parts so that they can be changed; and
second stage switching means for connecting a plurality of slot parts to said input/output ports of said plurality of hosts so that a combination of said input/output ports and said plurality of slots can be changed.

3. The PCI Express link according to claim 1, further comprising an external controller that monitors each state of said plurality of hosts and said plurality of slot parts, while controlling each operation of said first stage and said second stage switching means according to a monitored result.

4. The PCI Express link according to claim 3, wherein said external controller has a management table that stores as updating an association between said monitored result of said plurality of hosts and said plurality of slot parts and said contents of control operations of said first stage and said second stage switching means that should be taken according to said monitored result.

5. The PCI Express link according to claim 1, further comprising a substitute switching means that can be used in place of said second stage switching means, if said second stage switching means fails.

6. The PCI Express link according to claim 1, wherein said plurality of hosts have a first host and a second host, wherein
said first stage switching means comprises:
a first link controller for setting lane assign and number of lanes of said input/output ports of said first host, and a second link controller for setting lane assign and number of lanes of said input/output ports of said second host, and
said second stage switching means comprises:
a cross point switch for connecting said input/output ports of said first and said second host with said plurality of slot parts so that a combination of said input/output ports and said plurality of slots can be changed.

7. The PCI Express link according to claim 1, wherein a multi host computer system comprises said plurality of hosts and said plurality of slot parts.

8. A method for reconfiguring a PCI Express link comprising: a first stage and a second stage switching process that connects a plurality of slots to a plurality of hosts so that a combination of said plurality of hosts and said plurality of slot parts and a bandwidth of the connect channel can be changed.

9. A method for reconfiguring a PCI Express link, comprising:
first stage switching process for setting lane assign and number of said lanes connected to a plurality of slot parts so that they can be changed; and
second stage switching process for connecting a plurality of slot parts to said input/output ports of said plurality of hosts so that a combination of said input/output ports and said plurality of slots can be changed.

10. The method for reconfiguring the PCI Express link according to claim 8, further comprising: an external controlling process that monitors each state of said plurality of hosts and said plurality of slot parts, while controlling each operation of said first stage and said second stage switching process according to a monitored result.

11. The method for reconfiguring the PCI Express link according to claim 10, wherein in said external control process, association between said monitored result of said plurality of hosts and said plurality of slot parts and control operations of said first stage and said second stage switching process that should be taken according to said monitored result is stored as updated.

12. The method for reconfiguring the PCI Express link according to claim 8, further comprising a substitute switching process that is executed in place of said second stage switching process, if said second stage switching process fails.

13. The method for reconfiguring the PCI Express link according to claim 8, wherein said plurality of hosts have a first host and a second host, and
wherein said first stage switching process comprises a first link controlling process of setting lane assign and number of lanes of said input/output ports of said first host so that they can be changed, and a second link controlling process of setting said lane assign and said number of lanes of said input/output ports of said second host so that they can be changed, and
said second stage switching process comprises a cross point switching process that connects said input/output ports of said first and said second hosts with said plurality of slot parts so that a combination of said input/output ports and said plurality of slots can be changed.

14. The PCI Express link according to claim 2, wherein a multi host computer system comprises said plurality of hosts and said plurality of slot parts.

15. The PCI Express link according to claim 3, wherein a multi host computer system comprises said plurality of hosts and said plurality of slot parts.

16. The PCI Express link according to claim 4, wherein a multi host computer system comprises said plurality of hosts and said plurality of slot parts.

17. The PCI Express link according to claim 5, wherein a multi host computer system comprises said plurality of hosts and said plurality of slot parts.

18. The PCI Express link according to claim 6, wherein a multi host computer system comprises said plurality of hosts and said plurality of slot parts.
